(19) United States
(12) Patent Application Publication
(10) Pub. No.: US 2003/0073365 A1
(43) Pub. Date: Apr. 17, 2003

(54) Mat Mate

(76) Inventor: Linda Scott Waters, Houston, TX (US)

Correspondence Address: Linda Scott Waters, P.O. Box 710352, Houston, TX, 77271, US

(21) Appl. No.: 09/976,532

(22) Filed: Oct. 15, 2001

(51) Int. Cl. B32B 3/06; D04H 1/00

(52) U.S. Cl. 442/328

(57) ABSTRACT

The Mat Mate™ is a soft, comfortable, washable, mat covering that stays on a mat during mat use such as nap time and playtime.

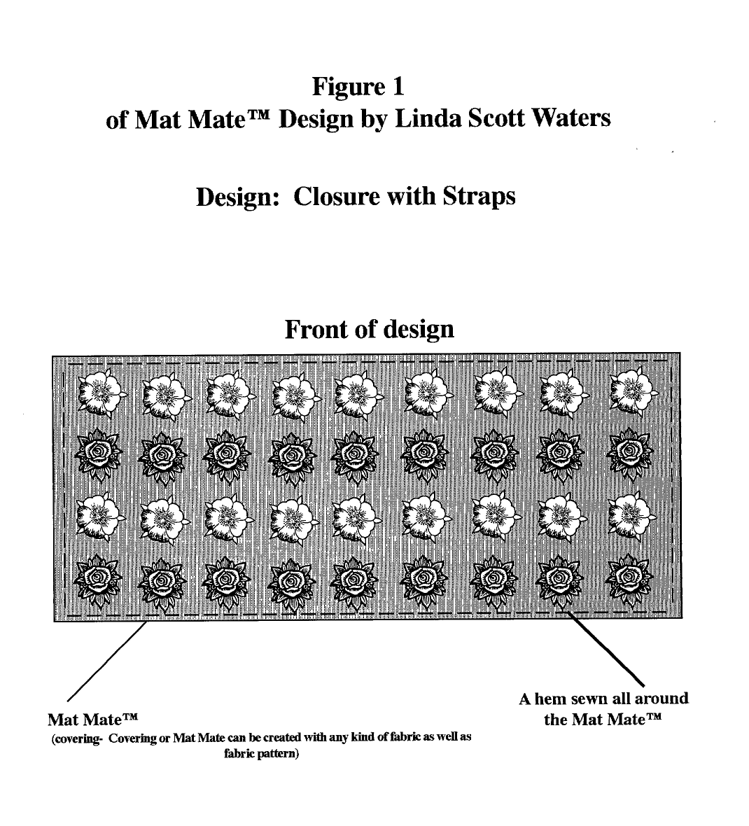

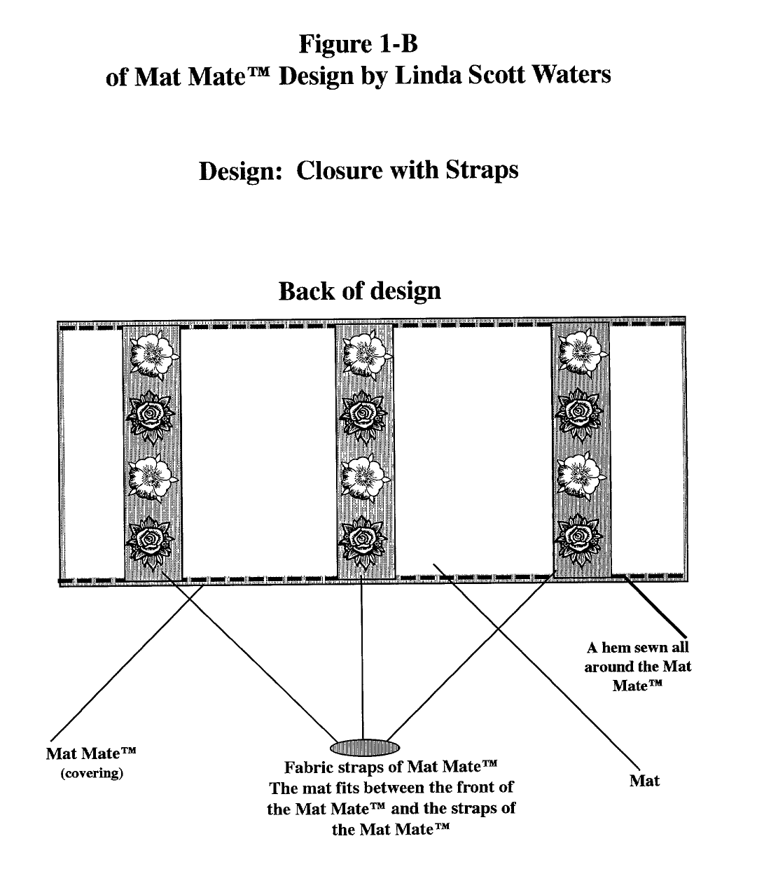

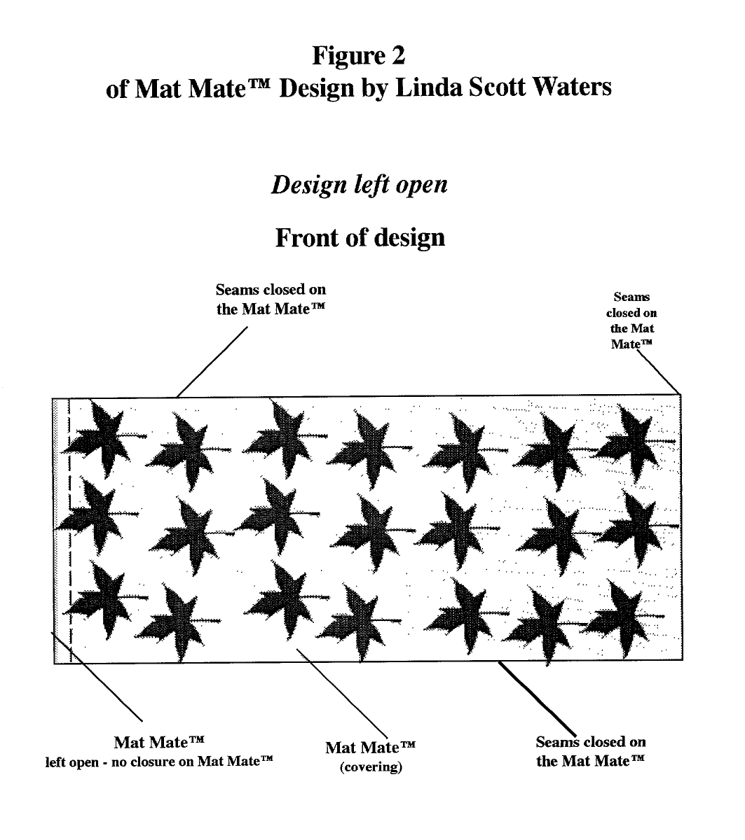

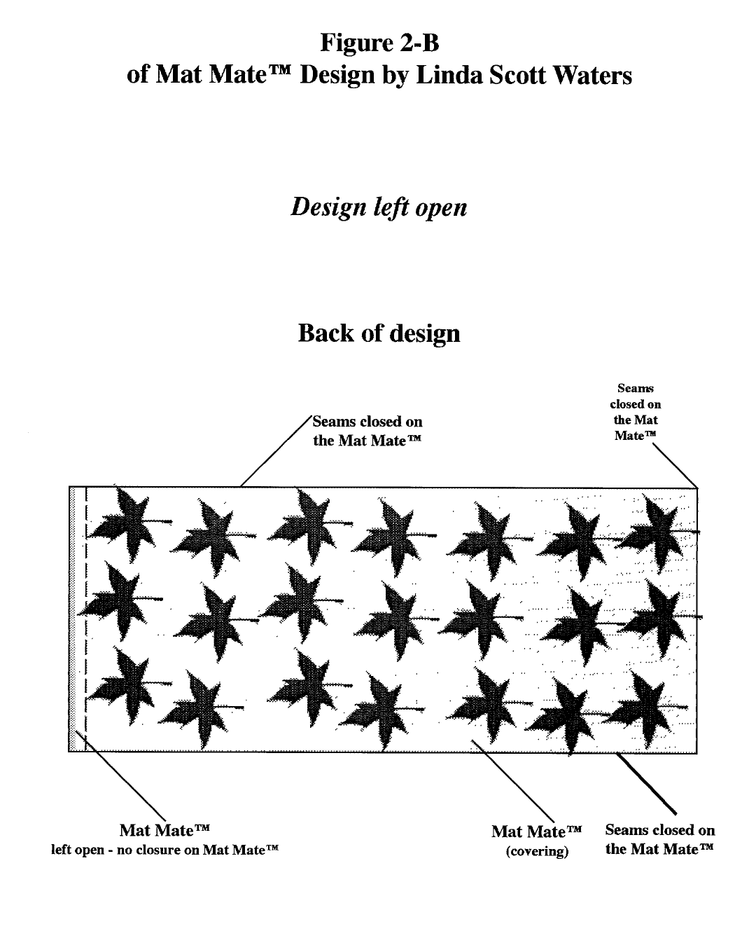

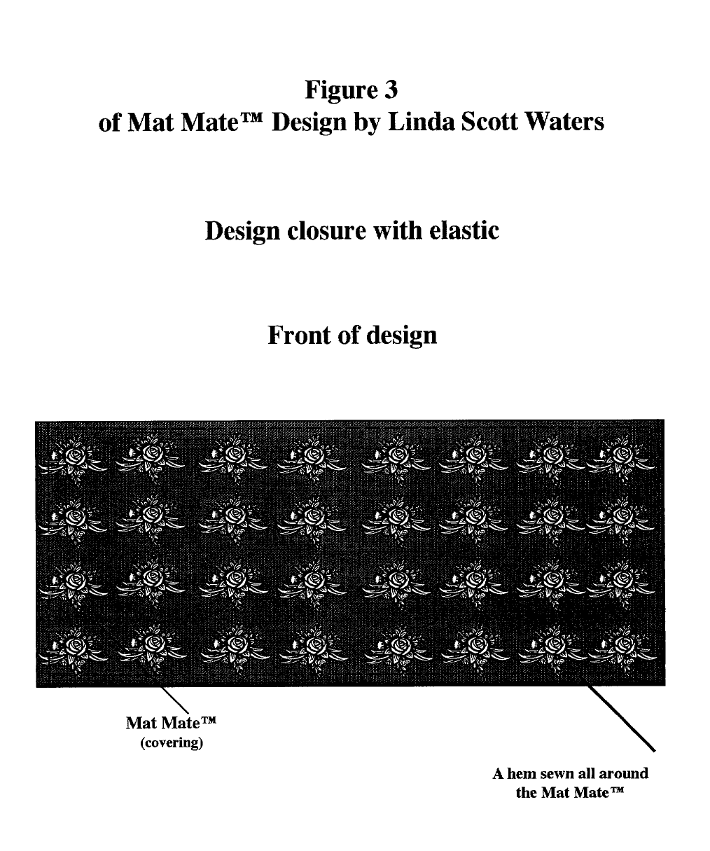

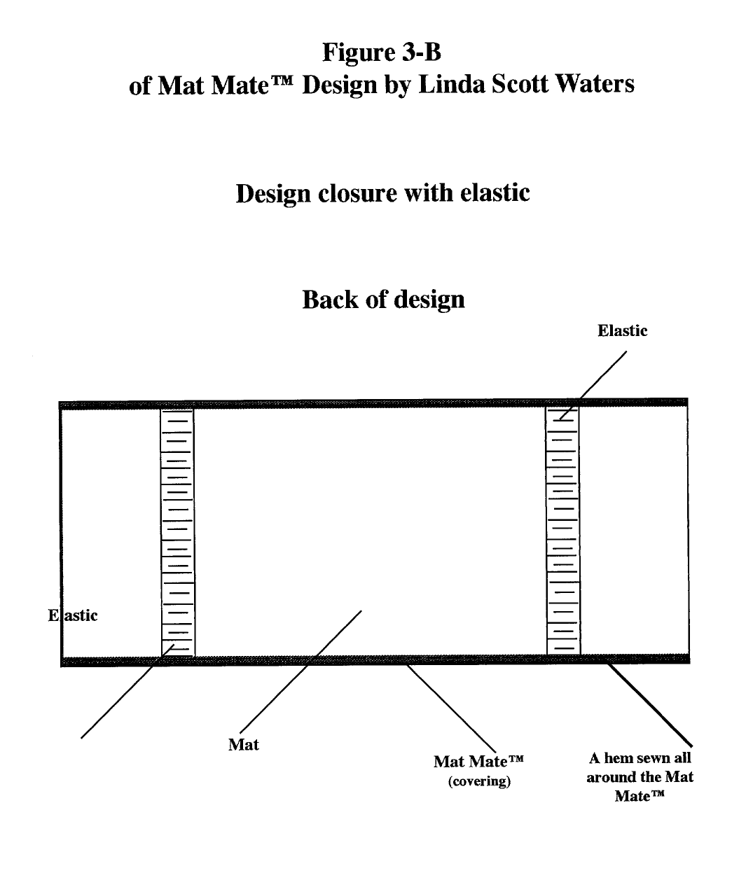

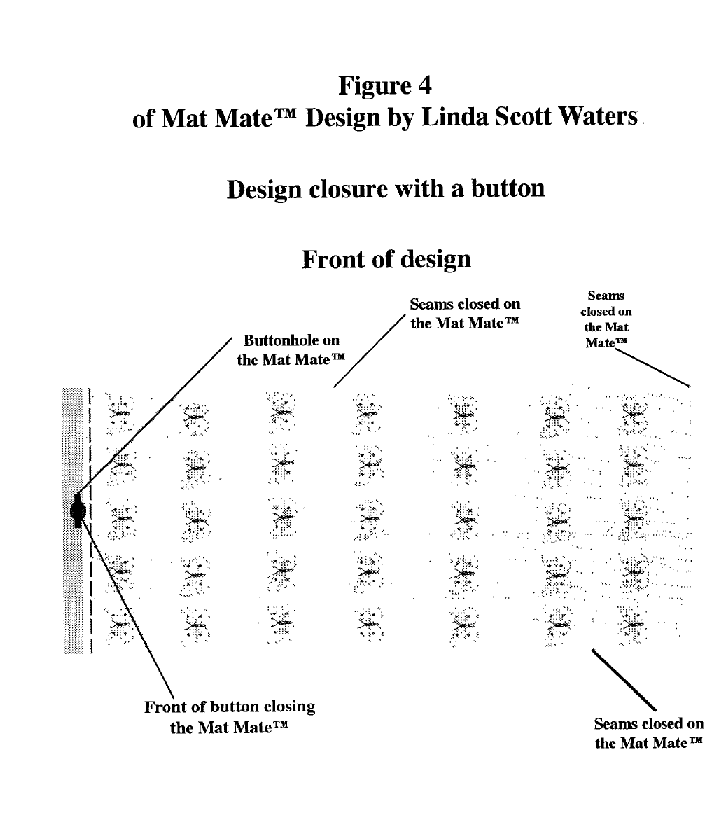

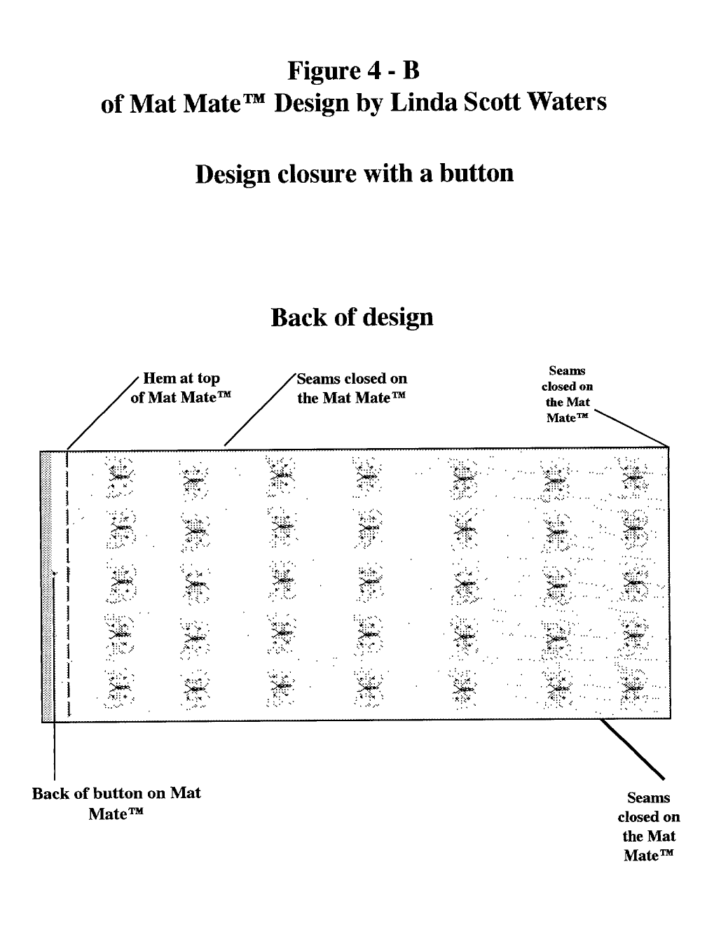

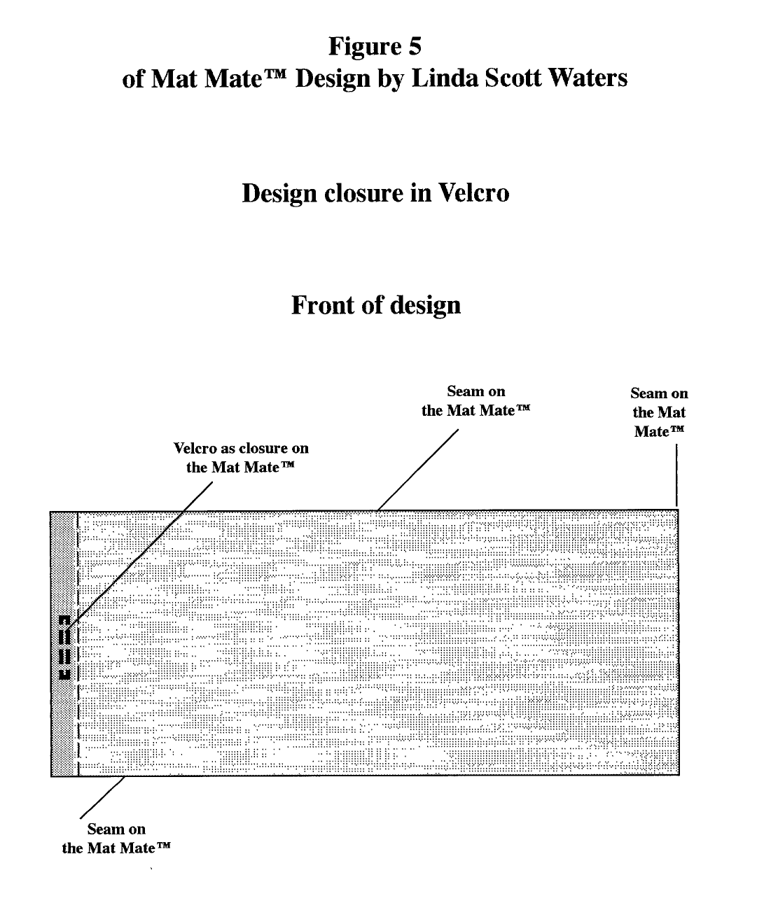

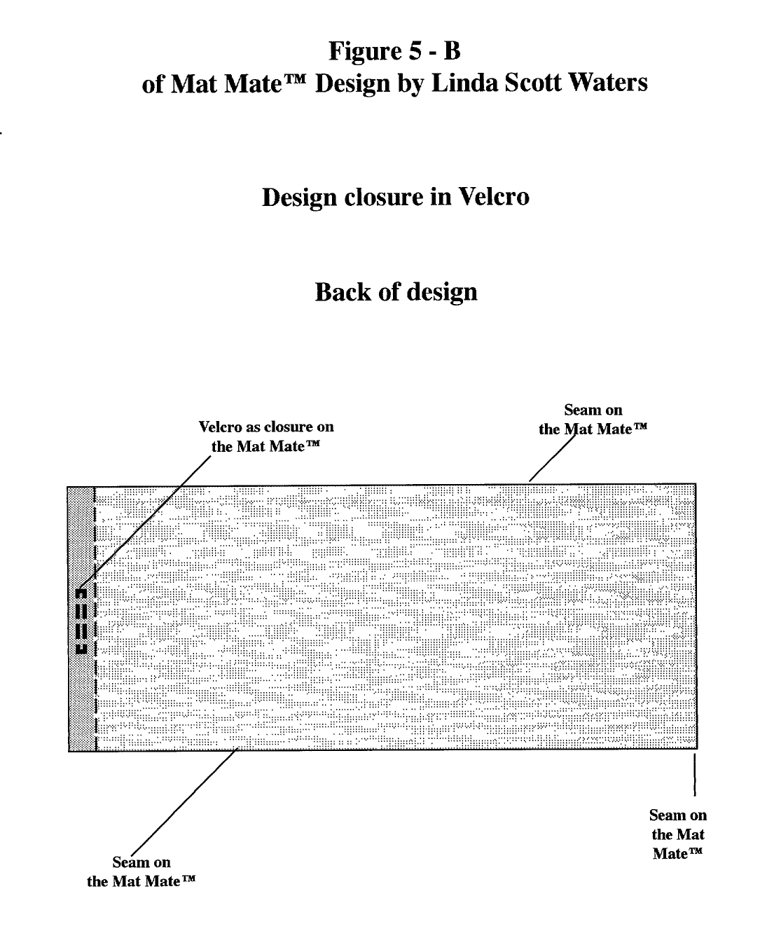

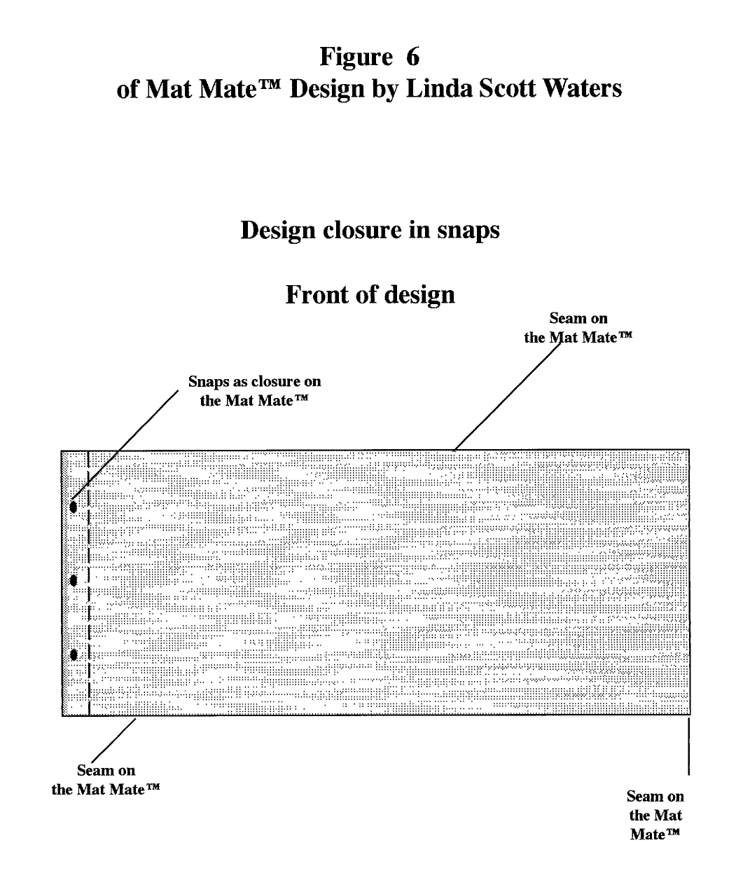

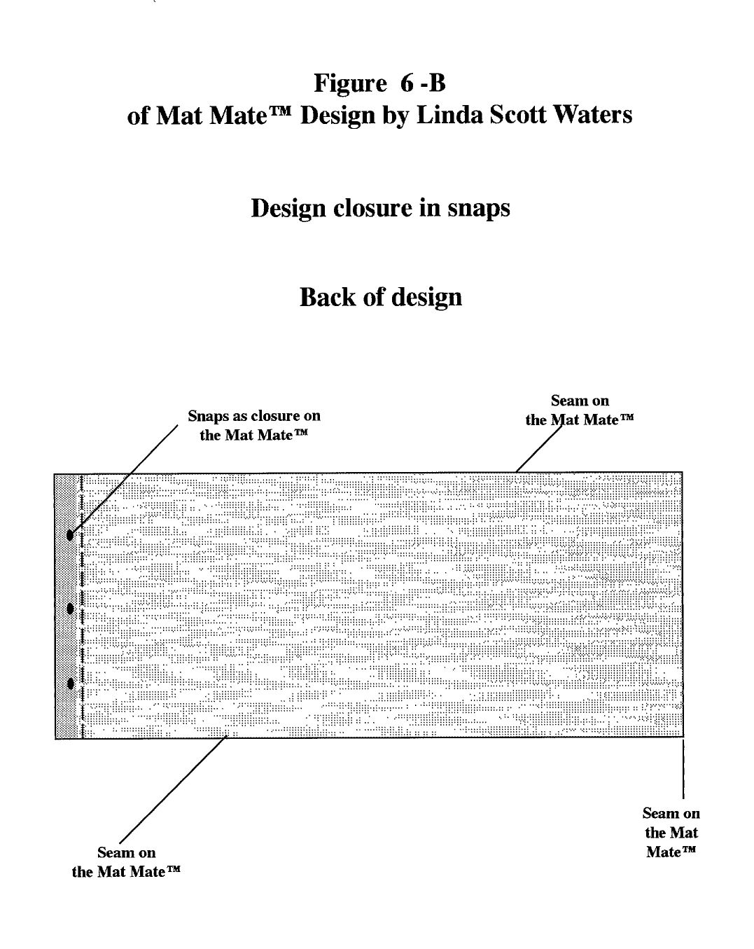

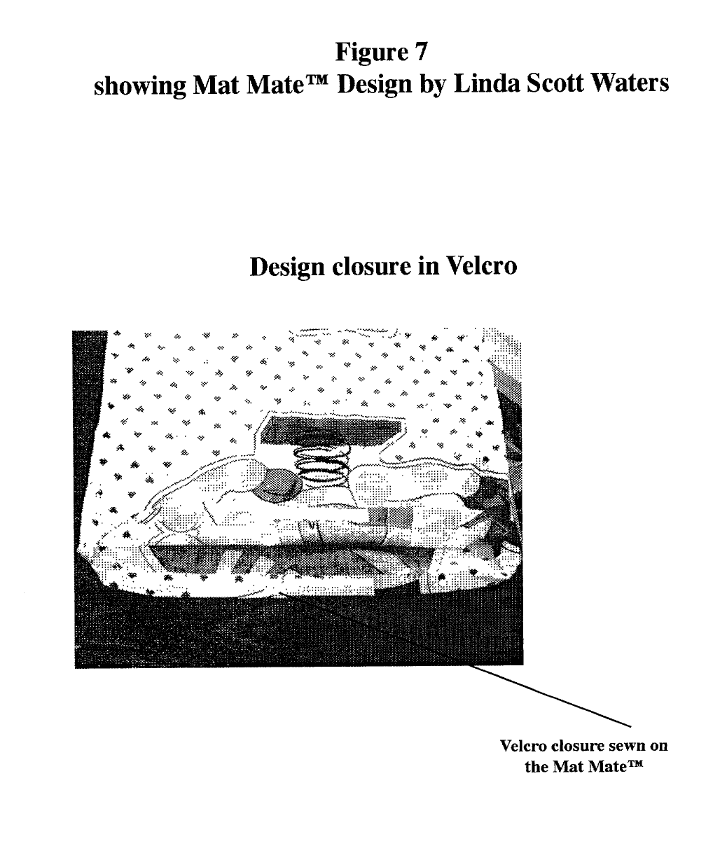

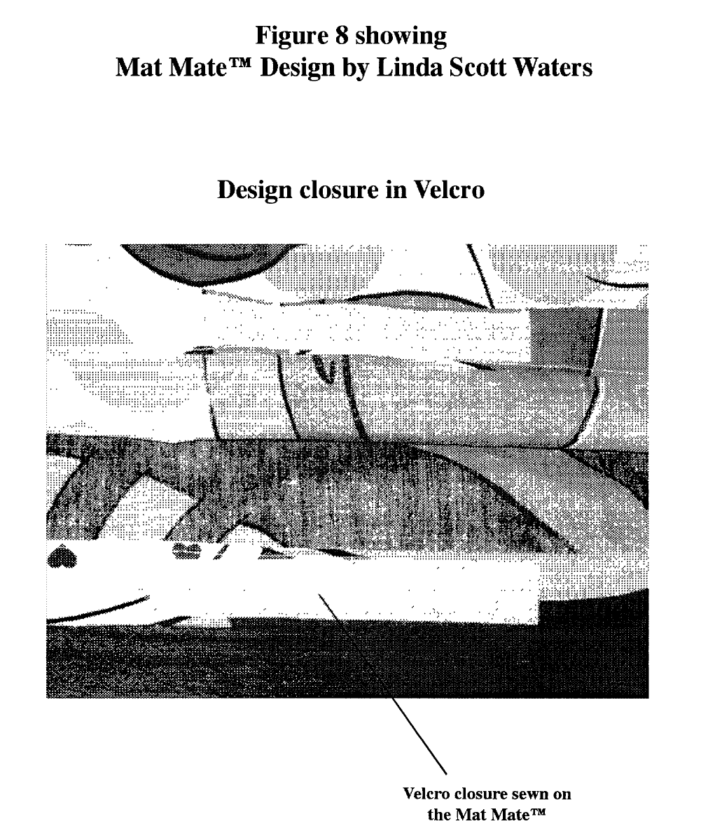

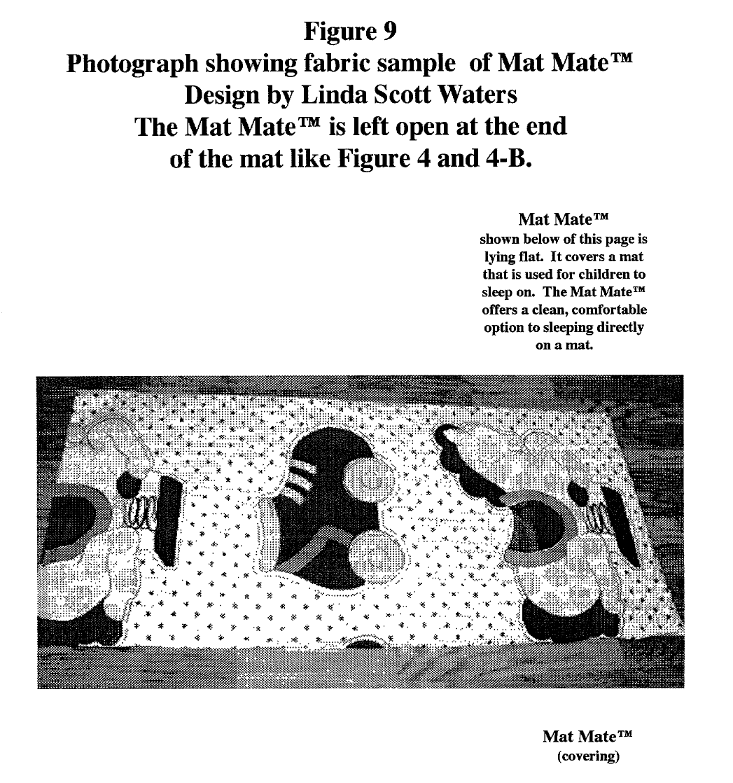

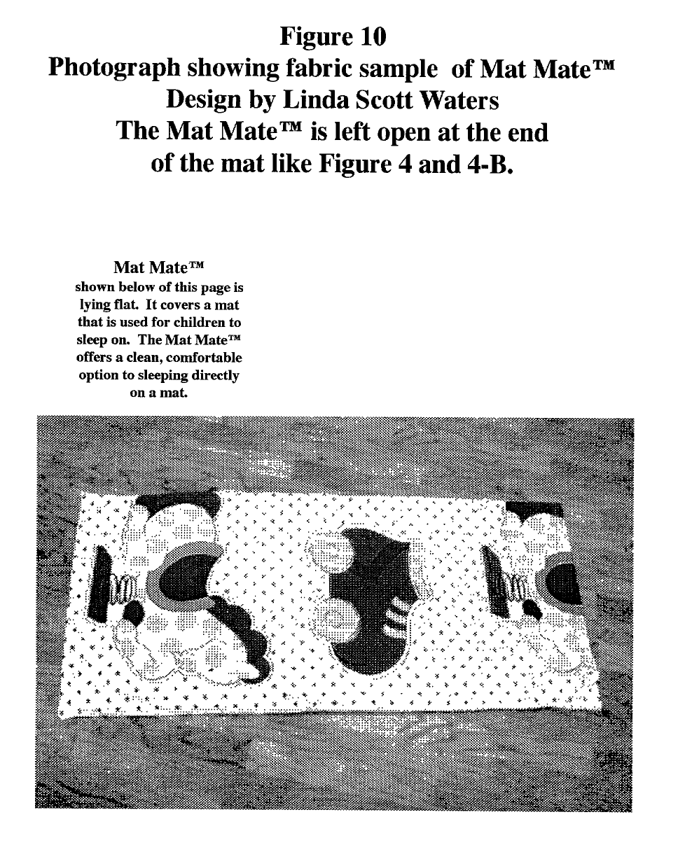

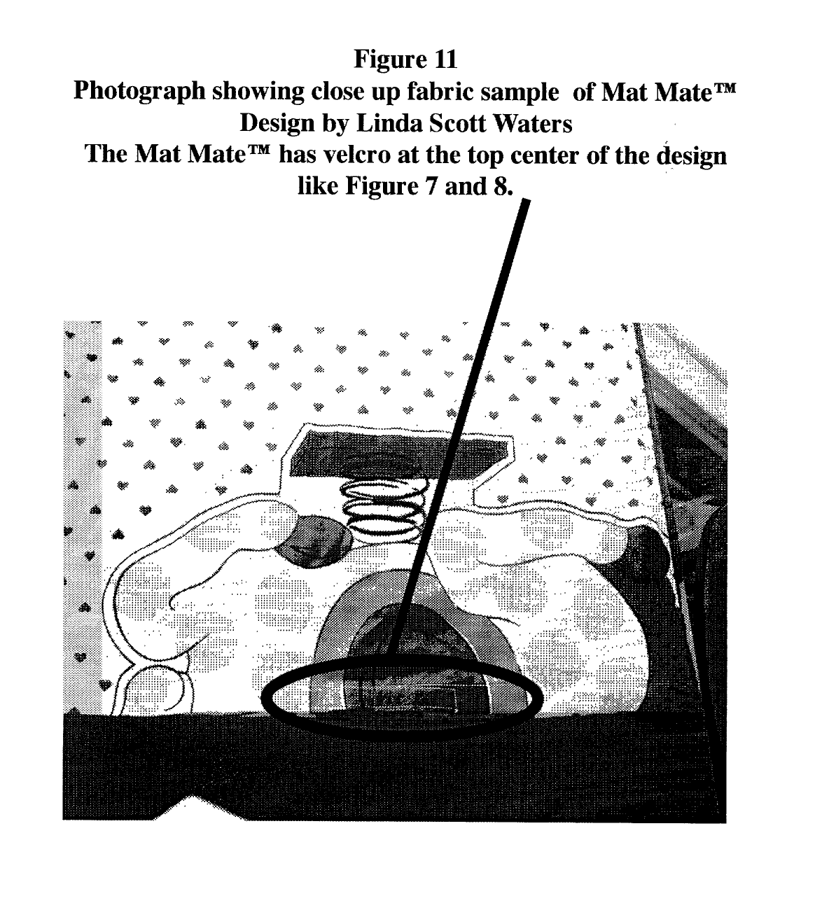

My invention is called a Mat Mate™ and hereby will be referred to as a Mat Mate™ throughout the course of this document.

The Mat Mate™ is a mat covering that has been created out of fabric. The fabric used in constructing the Mat Mate™ can be in various colors and patterns. The Mat Mate™ is used to cover a mat in a variety of ways and manners as illustrated in the drawings and photographs enclosed.

Mat Mate™ is used to keep a person from lying on plastic and/or vinyl materials that mats, especially floor mats, are made of. Mat Mate™ is a washable companion to a person's floor mat. A Mat Mate™ is designed to stay on the mat until removed. Mat Mate™ does not move off the mat like other coverings. It is designed to stay on the mat like a companion or “mate” while the person sleeps, rests, or plays.

Mat Mate™ offers great comfort to the user as Mat Mate™ keeps the mat cool in the summer when one tends to sweat on a mat, and Mat Mate™ keeps the user warm in the winter when one tends to feel cold on a cold vinyl mat.

The Mat Mate™ is approximately 45 inches long and 22 inches wide, but not limited to that size. A Mat Mate™ is designed to fit the size of any mat to offer a comforting alternative to a user other than lying directly on the mat.

### BACKGROUND OF THE INVENTION

My invention is called a Mat Mate™ and hereby will be referred to as a Mat Mate™. It covers a mat so that a person does not have to lie directly on a mat. Mat Mate™ offers a person an alternative to lying directly on vinyl or plastic which is what most mats are made of.

Mat Mate™ is a one-piece design.

Category—We will manufacture the Mat Mate™ with fabric in the United States of America.

Field of Invention—Domestic—Child Care

Before Mat Mate™ was invented, parents and day care workers had to cover mats with towels or blankets, if anything at all, and the towels nor the blankets stayed on the mat while the child slept. The child would always inadvertently end up sweating and consequently, with his face and body stuck to the mat. The vinyl and plastic tend to make the face and skin irritable when pressed against it. Mat Mate™ eliminates that problem by allowing the person to rest his face comfortably against the soft, washable fabric that is the invention of Mat Mate™.

### BRIEF SUMMARY OF THE INVENTION

My invention is called a Mat Mate™ and hereby will be referred to as a Mat Mate™.

Mat Mate™ is a one-piece design.

The Mat Mate™ solves the existing problem of people, normally children, lying on a plastic and/or vinyl mat during nap time in nursery schools, grammar schools, and elsewhere. A Mat Mate™ can be laundered and reused to maintain a sanitary sleep environment for the person sleeping or resting on it.

### DETAILED DESCRIPTION OF THE INVENTION (8 DRAWINGS)

Mat Mate™ is a one-piece design.

Drawing #1 has straight full-sized front (approximately 45 inches long and 22 inches wide) but can be enlarged or made smaller depending upon the size of the mat that it is covering. Mat Mates™ are not limited to any particular size of mat. Mat Mates™ are coverings for mats. The back on drawing #1 has three strips of fabric used as crossbars to keep the Mat Mate™ in place while the mat is inside.

The Mat Mate™ is a one-piece design.

The mat fits between the front of the Mat Mate™ and the three straps on the back of the Mat Mate™. There is a small hem sewn all around the four sides of the Mat Mate™, but drawing #1 remains open and seamless.

Drawing #2 of the Mat Mate™ is constructed the same on the front as well as the back of the invention. It is approximately 45 inches long and 22 inches wide, but can be enlarged or made smaller depending upon the size of the mat that it is covering. Mat Mates™ are not limited to any particular size of mat. Mat Mates™ are coverings for mats.

The opening on the Mat Mate™ in drawing #2 is left open at the top after insertion. There is a hem sewn at the top of the Mat Mate™. The sides and the bottom of the Mat Mate™ are sewn closed.

Drawing #3 of the Mat Mate™ is constructed with the front of the design being approximately 45 inches long and 22 inches wide, but the back of the Mat Mate™ is constructed with two or three strips of elastic to keep the mat enclosed inside the Mat Mate™. Drawing #3 has a small hem sewn all around the four sides of the Mat Mate™, but drawing #3 remains open and seamless.

Drawing #4 of the Mat Mate™ is constructed the same on the front as well as the back of the invention. It is approximately 45 inches long and 22 inches wide, but can be enlarged or made smaller depending upon the size of the mat that it is covering. Mat Mates™ are not limited to any particular size of mat. Mat Mates™ are coverings for mats.

The opening on the Mat Mate™ in drawing #4 is closed at the top with a button after insertion of the mat inside the invention. The button and buttonhole helps keep the mat inside.

Drawing #5 of the Mat Mate™ is constructed the same on the front as well as the back of the invention. It is approximately 45 inches long and 22 inches wide, but can be enlarged or made smaller depending upon the size of the mat that it is covering. Mat Mates™ are not limited to any particular size of mat. Mat Mates™ are coverings for mats.

The opening on the Mat Mate™ in drawing #5 is closed at the top after insertion of the mat with a strip of Velcro to help keep the mat enclosed inside the Mat Mate™.

Drawing #6 of the Mat Mate™ is constructed the same on the front as well as the back of the invention. It is approximately 45 inches long and 22 inches wide, but can be enlarged or made smaller depending upon the size of the mat that it is covering. Mat Mates™ are not limited to any particular size of mat. Mat Mates™ are coverings for mats.

The opening on the Mat Mate™ in drawing #6 is closed at the top after insertion of the mat with snaps to help keep the mat enclosed inside the Mat Mate™.

[image]

[image]

What I claim as my invention is Mat Mate™:

1. Mat Mate™ is a fabric-covering for a mat to keep children from lying directly on a vinyl mat.
The uniqueness of the invention Mat Mate™ is Mat Mate™ stays on the mat even during nap time and other activities. The Mat Mate™ is enclosed around the mat, therefore, the mat is always covered.
Mat Mate™ is exclusive as there are no other similar products of its kind and uses invented.
Since Mat Mate™ has a variety of closures; its practical application is a one-step closure. Several designs: drawing #1, drawing #2, and drawing #3 are open.
